(19) United States
(12) Patent Application Publication
(10) Pub. No.: US 2004/0131716 A1
(43) Pub. Date: Jul. 8, 2004

(54) Device for producing double-walled corrugated pipes

(76) Inventor: Gerhard Neubauer, Konigsberg (DE)

Correspondence Address: George A Coury, Bachman & LaPointe, Suite 1201, 900 Chapel Street, New Haven, CT, 06510-2802, US

(21) Appl. No.: 10/473,905

(22) PCT Filed: Mar. 11, 2002
(86) PCT No.: PCT/DE02/00846

(30) Foreign Application Priority Data
Apr. 6, 2001 (DE) 101 17 126.9

(51) Int. Cl. B29C 47/06

(52) U.S. Cl. 425/326.1; 425/392

(57) ABSTRACT

Described is an apparatus for producing double-walled corrugated pipes (72) comprising an extrusion nozzle (12) and a cooling mandrel (14) which protrude into a molding passage (16) formed by corrugator molding jaws (18, 20). The extrusion nozzle (12) has a first annular nozzle opening (34) for delivering an outer shell (62) and a second annular nozzle opening (40) for delivering an inner shell (64). The outer shell (62) delivered from the first annular nozzle opening (34) is sucked in the molding passage (16) by means of a vacuum against the corrugated transversely ribbed inner surface (66) of the corrugator molding jaws (18, 20). In order to prevent a reduced pressure which thereby acts on the inner shell, that is to say to prevent a pressure difference between the inside and the outside of the inner shell (64) which issues from the second annular nozzle opening (4), the extrusion nozzle (12) has at least one first and at least one second venting hole (74) and (76) which are in fluid communication with the atmosphere surrounding the apparatus.

The invention concerns an apparatus for producing double-walled corrugated pipes with a corrugated outer pipe and a smooth inner pipe, in particular double-walled corrugated pipes of a nominal diameter <40 mm, comprising an extrusion nozzle and a cooling mandrel which is provided upstream of the extrusion nozzle and which projects into a molding passage formed by corrugator molding jaws, wherein the corrugator molding jaws can be connected along the molding passage to a vacuum source, the extrusion nozzle has a first nozzle passage with a first annular nozzle opening and a second nozzle passage with a second annular nozzle opening, the first annular nozzle opening is provided for the delivery of an outer shell which to form the corrugated outer pipe in the molding passage is sucked against the corrugated transversely ribbed inner surface of the corrugator molding jaws and the second annular nozzle opening is provided for the delivery of an inner shell which to form the smooth inner pipe is pushed on to the cooling mandrel and in that case is connected in material-locking relationship to the corrugation troughs of the corrugated outer shell.

An apparatus of that kind is known for example from FIG. 9 and the related description of EP 0 543 243 A1. It is described therein that the outer shell issuing from the first annular nozzle opening is caused to bear against the corrugated transversely ribbed inner surface of the corrugator molding jaws by a gas pressure which is operative on the inside or by a vacuum which is operative on the outside. The fact that the outer shell issuing from the first annular nozzle opening is sucked against the transversely ribbed inner surface of the corrugator molding jaws forming the molding passage gives rise to the formation in the space between the outer shell and the inner shell issuing from the second annular nozzle opening of a reduced pressure from which a corrugated inner pipe can result. In order to avoid the formation of such a corrugated inner pipe, the apparatus known from EP 0 543 243 A1 provides that the inner shell mouthpiece of the extrusion nozzle is axially sufficiently far spaced from the outer shell mouthpiece and has a mandrel end ring and a funnel-shaped torpedo mouthpiece. In that known apparatus the inner shell mouthpiece so-to-speak projects freely from the outer shell mouthpiece, which means that the degree of rigidity of the cantilever structure is correspondingly slight. Such a low level of stiffness in the cantilever structure however can result in oscillations of the inner shell mouthpiece, with the cooling mandrel connected thereto. Oscillations of that kind have a negative influence on the quality of the double-walled corrugated pipe produced and in the extreme case can result in production wastage.

An apparatus for the production of double-walled corrugated pipes comprising a corrugated outer pipe and a smooth inner pipe, in particular double-walled corrugated pipes of a large nominal diameter, is known for example from WO 00/07801. In that known apparatus the intermediate space between the inside of the outer shell which issues from a first annular nozzle opening and the outside of the inner shell which issues from a second annular nozzle opening is subjected to the action of an increased pressure in order to cause the outer shell in the molding passage of the corrugator molding jaws to bear against the corrugated transversely ribbed inner surface of the corrugator molding jaws. That increased pressure also acts on the inner shell which issues from the second annular nozzle opening and consequently also influences the quality of the double-walled corrugated pipe produced. That is the case in particular if a thin-walled double-walled corrugated pipe of relatively small diameter is to be produced.

DE 43 25 021 C1 describes a method and an apparatus for the production of plastic transversely ribbed pipes with an inner layer with a smooth inner pipe surface and an outer layer with a corrugated outer surface. The material used therein for the outer layer is a washed and crushed recycled material which is composed of different kinds of materials and which is mixed with a suitable propellent for example in a plug mechanism and introduced through a first extruder into an injection head in which it is separated from the as-new material for the tubular inner layer and at the same time issues surrounding it concentrically, wherein the material for the outer layer, after issuing from the injection head, foams up in the space between the inner layer and the molding jaws of a corrugator, which form a molding passage. Those ribbed pipes are therefore not hollow-profiled double-walled corrugated pipes with a corrugated outer pipe and a smooth inner pipe, but ribbed pipes with a smooth inner pipe and a solid-material outer pipe with a corrugated outside surface.

DE 41 28 654 A1 discloses a multi-layer conduit pipe of plastic material and an apparatus for the production thereof. That known apparatus has an extrusion nozzle and a cooling mandrel which is disposed upstream of the extrusion nozzle, the nozzle and the cooling mandrel projecting into a molding passage formed by corrugator molding jaws. The extrusion nozzle has a first nozzle passage with a first annular nozzle opening and a second nozzle passage with a second annular nozzle opening. The first annular nozzle opening is provided for the delivery of an outer shell which to form the corrugated outer pipe in the molding passage is sucked against the corrugated transversely ribbed inner surface of the corrugator molding jaws or is pressed by means of a feed of compressed air against the corrugated transversely ribbed inner surface of the corrugator molding jaws. The second annular nozzle opening is provided for the delivery of an inner shell which to form the smooth inner pipe is pushed on to the cooling mandrel and, in the joint molding passage of the corrugator molding jaws, is connected in material-locking relationship to the corrugation troughs of the corrugated outer shell. If a vacuum is used in that known apparatus to suck the outer shell against the corrugated transversely ribbed inner surface of the corrugator molding jaws in the molding passage, then—as has already been referred to hereinbefore in connection with EP 0 543 243 A1—a reduced pressure is produced in the space between the outer shell which is sucked against the molding jaws and the inner shell which is pushed on to the cooling mandrel, and that reduced pressure can result in an inner pipe which is of an undesirably corrugated configuration. In the extreme case, or when the inner shell is thin, the procedure can even result in the inner shell being prematurely lifted off at or in the corrugation troughs of the outer shell, whereby the quality of the double-walled corrugated pipes produced is adversely affected or production wastage can occur. A corresponding consideration applies when using compressed air, this can also result in an undesirably corrugated inner pipe. In addition, this known apparatus also provides that the cooling mandrel is mounted to the extrusion nozzle in a freely cantilevered position so that oscillations of the cooling mandrel often cannot be avoided during production of the double-walled corrugated pipes. Such oscillations have a corresponding adverse effect on the quality of the double-walled corrugated pipes produced, as has already been mentioned above.

The foregoing comments also apply in the same manner to the apparatus known from EP 0 420 019 A2. An apparatus for shaping double-walled corrugated pipes is also known for example from DE 200 11 667 U1. That known apparatus has an extrusion nozzle and a molding passage, along which the double-walled corrugated pipe is formed. The molding passage is defined by corrugator molding jaws which rotate along two paths and form the molding passage along a common portion of those two paths. Plastic material is fed to the extrusion nozzle from a plurality of feeds. The plastic material from the feeds passes into a common duct in the extrusion nozzle. That common duct conveys the plastic material to a first and a second annular nozzle opening. That known extrusion nozzle has a separator for the plastic material, which in the flow direction of the plastic material is disposed upstream of the annular nozzle openings and which establishes which plastic material or what quantity of the plastic material flows into which of the two annular nozzle openings. The separator therefore determines from which of the feeds comes the plastic material which leaves the first and the second annular nozzle openings. The separator can also be arranged in the annular nozzle openings or at the downstream end of the annular nozzle openings, as is described on page 3, paragraph 4 of that specification.

An apparatus for the production of double-walled corrugated pipes with a corrugated outer pipe and a smooth inner pipe is also described for example in DE 298 13 235 U1. That known apparatus has an extrusion nozzle and a cooling mandrel arranged upstream of the extrusion nozzle. The extrusion nozzle projects with the cooling mandrel into a molding passage formed by corrugated molding jaws. The extrusion nozzle has a first nozzle passage with a first annular nozzle opening and a second nozzle passage with a second annular nozzle opening. The first annular nozzle opening is provided for the delivery of an outer shell which to form the corrugated outer pipe in the molding passage is caused to bear against the corrugated transversely ribbed inner surface of the corrugator molding jaws. That can be effected by applying a vacuum to the corrugator molding jaws which are then disposed in the molding passage. In addition it is possible to use compressed air to urge the outer shell issuing from the first annular nozzle opening against the corrugated transversely ribbed inner surface of the corrugator molding jaws which are disposed in the molding passage. The deficiencies which arise out of that operating procedure, that is to say due to the applied vacuum or the applied increased pressure, have already been discussed hereinbefore in connection with the known state of the art. They also correspondingly apply here.

DE 24 13 878 B2 discloses a method and an apparatus for producing a double-walled plastic pipe with a corrugated outer wall and a smooth inner wall, by simultaneous extrusion of two concentric pipes, shaping of the outer pipe using reduced pressure by sucking it in between divided chill molds with transverse groves, which are guided in a circuit and which supplement each other to constitute the hollow shape, and subsequent welding of the inner pipe to the corrugated outer pipe. In that case, passed into the space between the two pipes is supporting air, the pressure of which is above atmospheric pressure and the temperature of which is at least as high as the softening temperature of the plastic material. It is preferred in that case if the supporting air which is introduced into the interior of the inner pipe, which can be shut off in relation to the outside air, is supplied under a pressure which is above atmospheric pressure. The supporting air which is fed into the space between the two pipes is preferably fed under a pressure which is above atmospheric pressure by between about 10 and 20%. The supporting air which is fed into the interior of the inner pipe is preferably fed under a pressure which is above atmospheric pressure by between about 15 and 30%.

The object of the invention is to provide an apparatus of the kind set forth in the opening part of this specification, with which it is possible in particular to produce double-walled corrugated pipes of small nominal diameter with a thin corrugated outer pipe and a thin smooth inner pipe, with a high level of productivity and of high quality.

In accordance with the invention, in an apparatus of the kind set forth in the opening part of this specification, that object is attained in that the extrusion nozzle is provided with at least one venting hole which opens into a first cavity between the outer shell issuing from the first annular nozzle opening and sucked against the corrugated transversely ribbed inner surface of the corrugator molding jaws and the inner shell issuing from the second annular nozzle opening and pushed on to the cooling mandrel and connected in material-locking relationship to the corrugation troughs of the corrugated outer shell in the molding passage, that the extrusion nozzle has at least one second venting hole which opens into a second cavity between the inner shell and the cooling mandrel and the extrusion nozzle, and the at least one venting hole and the at least one second venting hole are connected to a venting passage which discharges into the external atmosphere.

The apparatus according to the invention has the advantage that the reduced pressure caused by the outer shell being sucked against the corrugated transversely ribbed inner surface of the respective corrugator molding jaws in the molding passage, in the first cavity, is eliminated and that there is also no pressure difference between the outside and the inside of the inner shell, that is to say the pressure is equalised at the inside and the outside of the inner shell so that unwanted corrugation of the inner shell is prevented in a structurally simple fashion. Consequently, by means of the apparatus according to the invention, it is possible to produce double-walled corrugated pipes of a small nominal diameter of <40 mm without any problem, in which case the wall thickness of the corrugated outer pipe and the smooth inner pipe which is connected thereto in positively locking relationship can be small.

It has proven to be desirable if, in the apparatus according to the invention, the extrusion nozzle has a central inner mandrel, an outer shell inner sleeve coaxially surrounding the inner mandrel and an outer shell outer sleeve coaxially surrounding the outer shell inner sleeve, wherein a first flow passage discharging from the first annular nozzle opening is separated from a second flow passage discharging from the second annular nozzle opening by the outer shell inner sleeve, wherein the first and the second flow passages are separated from each other in the longitudinal direction of the extrusion nozzle, and wherein the at least one first venting hole and the at least one second venting hole open into the central inner mandrel which has the venting passage. The outer shell inner sleeve and the outer shell outer sleeve in that case form an outer shell mouthpiece, at the front end face of which is provided the first annular nozzle opening for the outer shell.

The cooling mandrel is fixed with its rear end portion to the front end portion of the central inner mandrel. The cooling mandrel at the same time desirably forms a calibrating mandrel for the smooth inner pipe of the double-walled corrugated pipe produced with the apparatus according to the invention.

It has been found to be advantageous if an inner shell mouthpiece having the second annular nozzle opening is fixed to the front end portion of the central inner mandrel, spaced from the rearward end of the cooling mandrel, wherein the at least one first venting opening extends through the central inner mandrel and through the inner shell mouthpiece and the at least one second venting opening is provided on the central inner mandrel in the region between the rearward end of the cooling mandrel and the front end of the inner shell mouthpiece. In that case the inner shell mouthpiece can have an end ring and a sleeve-shaped torpedo mouthpiece by which the second annular nozzle opening is defined. In such a configuration of the apparatus according to the invention the at least one first venting opening extends radially through the torpedo mouthpiece in order to provide flow communication of the first cavity which is delimited by the outer shell and the inner shell and the torpedo mouthpiece to the ambient atmosphere by way of the venting passage which extends through the extrusion nozzle or the central inner mandrel, so that a reduced pressure is avoided in the above-mentioned first cavity and a pressure difference is avoided between the outside and the inside of the inner shell.

It has proven to be particularly advantageous if the torpedo mouthpiece at its rear end remote from the end ring is provided with a cone surface which enlarges radially outwardly towards the first annular nozzle opening and the outer shell inner sleeve is provided at its front end with a cone support and centering surface which is adapted to the cone surface of the torpedo mouthpiece. Such a design configuration affords the advantage that the inner shell mouthpiece is supported both at the central inner mandrel and also at the outer shell mouthpiece, that is to say at the outer shell inner sleeve thereof, thereby increasing the level of cantilever stiffness. That increased cantilever stiffness means that vibration of the cooling mandrel is prevented. The annular gap between the cooling mandrel and the respective corrugator molding jaws which are in the molding section can therefore advantageously be very small without the fear of damage to the specified components. Consequently, very thin-walled double-walled corrugated pipes can be produced with such an apparatus according to the invention, at a high level of productivity.

With the apparatus according to the invention, it has been found to be advantageous if the central inner mandrel at its front end portion has a male screwthreaded portion and if the end ring of the inner shell mouthpiece has a female screwthread matching same and bears against an annular shoulder of the sleeve-shaped torpedo mouthpiece. By suitably screwing the end ring on to the central inner mandrel the sleeve-shaped torpedo mouthpiece is supported against the outer shell inner sleeve, that is to say the torpedo mouthpiece is supported with its cone surface against the cone support and centering surface of the outer shell inner sleeve, in centered relationship. The sleeve-shaped torpedo mouthpiece is arranged preferably without a gap on the central inner mandrel. The cooling mandrel can be screwed with a female screwthreaded portion on to the male screwthreaded portion of the central inner mandrel.

The apparatus according to the invention is relatively easily constructed from few components which can be assembled in a simple and precise manner, in which respect, it is possible, with the apparatus according to the invention, to produce double-walled corrugated pipes of any internal diameter and in particular double-walled corrugated pipes of small nominal diameter and of small wall thicknesses in respect of the curved outer pipe and the smooth inner pipe, at a high level of productivity and of high-grade quality.

Further details, features and advantages will be apparent from the description hereinafter of an embodiment illustrated in the drawing of the apparatus according to the invention for producing double-walled corrugated pipes. In the drawing:

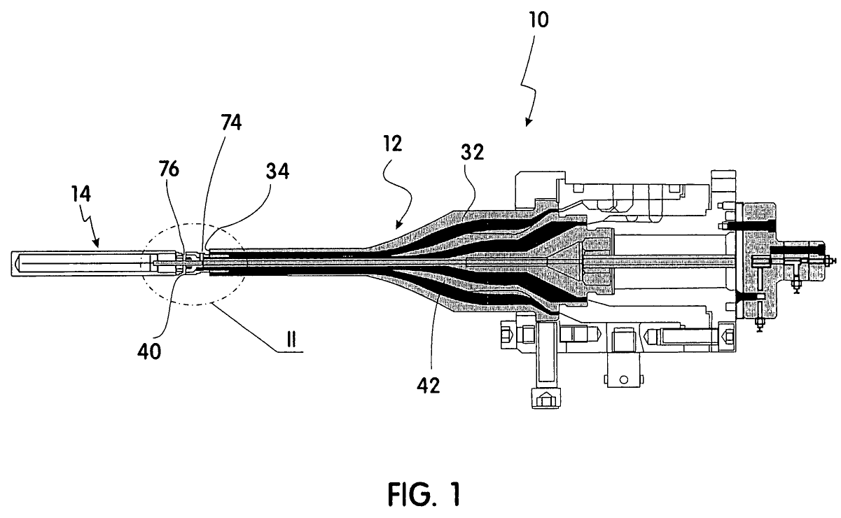

FIG. 1 is a view in longitudinal section of an embodiment of the injection head of the apparatus according to the invention with an extrusion nozzle and a cooling and calibrating mandrel provided upstream of the extrusion nozzle, and

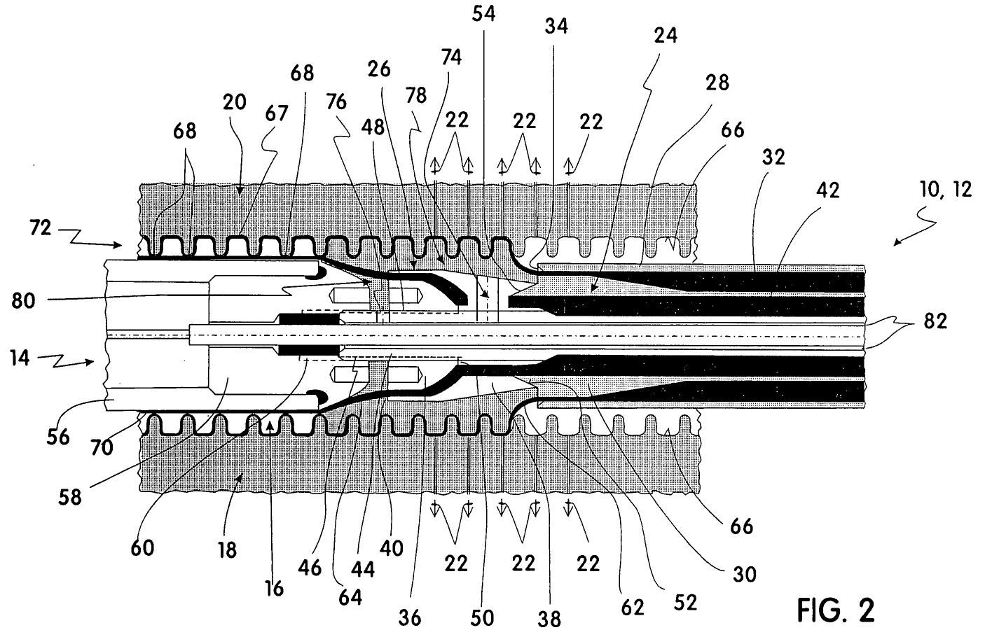

FIG. 2 is a view on a larger scale showing the detail II in FIG. 1, wherein portions of two corrugator molding jaws forming a common molding passage are also shown here.

FIG. 1 is a view in longitudinal section showing an injection head 10 for an apparatus for producing double-walled corrugated pipes. The injection head 10 has an extrusion nozzle 12 and a cooling mandrel 14 provided upstream of the extrusion nozzle 12. The extrusion nozzle 12 and the cooling mandrel 14 extend into a molding passage 16 which is defined by corrugator molding jaws 18 and 20. The corrugator molding jaws 18 rotate in known manner along a closed path of movement. The corrugator molding jaws 20 correspondingly rotate about a closed path of movement. Those two paths of movement extend in mutually adjacent parallel relationship along a certain section so that the corrugator molding jaws 18 and 20 along that common section form the molding passage 16. The corrugator molding jaws 18 and 20 can be connected along the molding passage 16 to a vacuum source (not shown). That is indicated in FIG. 2 by the arrows 22.

The extrusion nozzle 12 has an outer shell mouthpiece 24 and an inner shell mouthpiece 26. The outer shell mouthpiece 24 is formed by an outer shell outer sleeve 28 and an outer shell inner sleeve 30 which are arranged in mutually concentric relationship. Provided between the outer shell outer sleeve 28 and the outer shell inner sleeve 30 is a first nozzle passage 32 which extends through the extrusion nozzle 12 and which discharges from the outer shell mouthpiece 24 at the front end with a first annular nozzle opening 34.

The inner shell mouthpiece 26 has an end ring 36 and a sleeve-shaped torpedo mouthpiece 38. The end ring 36 and the torpedo mouthpiece 38 define a second annular nozzle opening 40. The second annular nozzle opening 40 is connected to a second nozzle passage 42. The second nozzle passage 42 is defined by the outer shell inner sleeve 24 and by a central sleeve-shaped inner mandrel 44. The second nozzle passage 42, like the first nozzle passage 32, extends through the extrusion nozzle 12. The first nozzle passage 32 and the second nozzle passage 42 are or can be connected to an extruder (not shown).

At its front end portion the central inner mandrel 44 has a male screwthreaded portion 46. The end ring 36 is provided with a female screwthread 48 and is screwed on to the male screwthreaded portion 46 of the central inner mandrel 44. The torpedo mouthpiece 38 is provided at its inside with a shoulder 50. In the assembled condition, the end ring 38 bears against the shoulder 50 of the sleeve-shaped torpedo mouthpiece 38.

At its front end, the outer shell inner sleeve 24 of the outer shell mouthpiece 24 has a cone support and centering surface 52. At its rear end the sleeve-shaped torpedo mouthpiece 38 has a cone surface 54 which enlarges radially outwardly towards the first annular nozzle opening 34 and which is adapted to the cone support and centering surface 52 of the outer shell inner sleeve 30.

The cooling mandrel 14 has a mandrel casing 56 which is closed at its rear by a plug 58. The plug 58 has a female screwthreaded portion 60 with which it is screwed on to the male screwthreaded portion 46 of the central inner mandrel 44. The inner shell mouthpiece 26 is fixed not only to the central inner mandrel 44 but also, by the cone surface 54 and the cone support and centering surface 52, to the outer shell mouthpiece 24, so that the cantilever stiffness is substantially increased. This increased cantilever stiffness correspondingly applies in regard to the cooling mandrel 14.

The first annular nozzle opening 34 is provided for the delivery of an outer shell 62 of extruded plastic material and the second annular nozzle opening 40 is provided for the delivery of an inner shell 64 of extruded plastic material. The plastic materials for the outer shell 62 and the inner shell 64 can be one and the same plastic material or plastic materials which are different from each other. The outer shell 62 which is produced from the first annular nozzle opening 34 is sucked by means of the vacuum indicated by the arrows 22 against the corrugated transversely ribbed inner surface 66 of the corrugator molding jaws 18 and 20 respectively disposed in the molding passage, in order to form a corrugated outer pipe 66. The inner shell 64 issuing from the second annular nozzle opening 40 is pushed on to the cooling mandrel 14 and connected in material-locking relationship along the cooling mandrel 14 to the corrugation troughs 60 of the corrugated outer shell 66 which is still in a plastic condition. The inner shell 64 then forms a smooth inner pipe 70 of the double-walled corrugated pipe 72. Downstream of the common molding section, in the advance direction, the corrugator molding jaws 18 and 20 are moved away from each other again and the finished double-walled corrugated pipe 72 is discharged from the apparatus. It is therefore possible by means of the apparatus to produce continuously, that is to say so-to-speak endlessly, a double-walled corrugated pipe 72.

In order to prevent unwanted corrugation of the inner shell 70 or indeed to prevent the inner shell 64 from prematurely adhering to the outer shell 62 when sucked against the corrugated transversely ribbed inner surface 66 of the corrugator molding jaws 18 and 20, the extrusion nozzle 12 has at least one first venting hole 74 and at least one second venting hole 76. The first venting hole 74 is in fluid communication with the outside of the inner shell 64 and the at least one second venting hole 76 is in fluid communication with the inside of the inner shell 64 so that no pressure difference but the pressure of the ambient atmosphere is effective at the inner shell. For that purpose the first venting hole 74 opens into a first cavity 78 which is delimited by the outer shell 62 which is sucked against the corrugated transversely ribbed inner surface 66 of the corrugator molding jaws 18 and 20, as far as the first annular nozzle opening 34, the inner shell 64 as far as the material-locking connection to the outer shell 62, the torpedo mouthpiece 38 and the end of the outer shell inner sleeve 30. The second venting hole 76 opens into a second cavity 80 which is delimited by the cooling mandrel 14, the central inner mandrel 44, the end ring 36 of the inner shell mouthpiece 26 and the inside of the inner shell 64. The second venting hole 76 extends in the region between the rearward end of the cooling mandrel 14 and the front end of the end ring 36 or the inner shell mouthpiece 26 through the wall of the central inner mandrel 44. The first fixing hole 74 extends through the wall of the central inner mandrel 44 and through the torpedo mouthpiece 38. The first and the second venting holes 74 and 76 are in flow communication with a venting passage 82 which extends through the central inner mandrel 44 and which discharges into the ambient atmosphere from the injection head 10. In that way, the first cavity 78 and the second cavity 80 are vented during operation of the injection head 10 so that the same pressure, namely the external air pressure, obtains at the inner shell 64 which issues from the second annular nozzle opening 40, at the inside and outside thereof. A reduced pressure at the outside of the inner shell 64 and thus a corrugated configuration of the inner pipe 70, which possibly results therefrom, as a consequence of the outer shell being sucked against the molding jaws 18 and 20, is prevented.

1. Apparatus for producing double-walled corrugated pipes (72) with a corrugated outer pipe (67) and a smooth inner pipe (70), in particular double-walled corrugated pipes (72) of a nominal diameter <40 mm, comprising an extrusion nozzle (12) and a cooling mandrel (14) which is provided upstream of the extrusion nozzle (12) and which projects into a molding passage formed by corrugator molding jaws (18, 20), wherein the corrugator molding jaws (18, 20) can be connected along the molding passage (16) to a vacuum source, the extrusion nozzle (12) has a first nozzle passage (32) with a first annular nozzle opening (34) and a second nozzle passage (42) with a second annular nozzle opening (40), the first annular nozzle opening (34) is provided for the delivery of an outer shell (62) which to form the corrugated outer pipe (67) in the molding passage (16) is sucked against the corrugated transversely ribbed inner surface (66) of the corrugator molding jaws (18, 20) and the second annular nozzle opening (40) is provided for the delivery of an inner shell (64) which to form the smooth inner pipe (70) is pushed on to the cooling mandrel (14) and is connected in material-locking relationship to the corrugation troughs (68) of the corrugated outer shell (61), wherein the extrusion nozzle (12) is provided with at least one first opening (74) which opens into a first cavity (78) between the outer shell (62) issuing from the first annular nozzle opening (34) and sucked against the corrugated transversely ribbed inner surface (66) of the corrugator molding jaws (18, 20) and the inner shell (64) issuing from the second annular nozzle opening (40) and pushed on to the cooling mandrel (14) and connected in material-locking relationship to the corrugation troughs (68) of the corrugated outer shell (62) and the extrusion nozzle (12) has at least one second opening (76) which opens into a second cavity (80) between the inner shell (64) and the cooling mandrel (14) and the inner shell mouthpiece (26),
characterised in that
the at least one first opening (74) is a first venting hole (74) and the at least one second opening (76) is a second venting hole (76), which are connected to a venting passage (82) which discharges into the external atmosphere.

2. Apparatus as set forth in claim 1 characterised in that the extrusion nozzle (12) has a central inner mandrel (44), an outer shell inner sleeve (30) concentrically surrounding the inner mandrel (44) and an outer shell outer sleeve (28) concentrically surrounding the outer shell inner sleeve (30), wherein a first nozzle passage (32) discharging from the first annular nozzle opening (34) is separated from a second nozzle passage (42) discharging from the second annular nozzle opening (40) by the outer shell inner sleeve (30), wherein the first nozzle passage (32) and the second nozzle passage (42) are separated from each other along the extrusion nozzle (12) and wherein the at least one first venting hole (74) and the at least one second venting hole (76) open into the venting passage (82) provided in the central inner mandrel (44).

3. Apparatus as set forth in claim 2 characterised in that the cooling mandrel (14) is fixed with its rearward end portion to the front end portion of the central inner mandrel (44).

4. Apparatus as set forth in claim 2 characterised in that fixed to the front end portion of the central inner mandrel (44) spaced from the rearward end of the cooling mandrel (14) is an inner shell mouthpiece (26) having the second annular nozzle opening (40), wherein the at least one first venting hole (74) extends through the central inner mandrel (44) and the inner shell mouthpiece (26) and the at least one second venting hole (74) is provided on the central inner mandrel (44) in the region between the rearward end of the cooling mandrel (14) and the front end of the inner shell mouthpiece (26).

5. Apparatus as set forth in claim 4 characterised in that the inner shell mouthpiece (26) has an end ring (36) and a sleeve-shaped torpedo mouthpiece (38) by which the second annular nozzle opening (40) is defined.

6. Apparatus as set forth in claim 5 characterised in that the at least one first venting hole (74) extends radially through the torpedo mouthpiece (38).

7. Apparatus as set forth in claim 5 or claim 6 characterised in that at its rearward end remote from the end ring (36) the torpedo mouthpiece (38) has a cone surface (54) enlarging radially outwardly towards the first annular nozzle opening (34) and at its front end the outer shell inner sleeve (30) has a cone support and centering surface (52) which is matched to the cone surface (54) of the torpedo mouthpiece (38).

8. Apparatus as set forth in one of claims 5 through 7 characterised in that at its front end portion the central inner mandrel (44) has a male screwthreaded portion (46) and the end ring (36) of the inner shell mouthpiece (36) has a female screwthread (48) matching same and bears against an annular shoulder (50) of the sleeve-shaped torpedo mouthpiece (38).

9. Apparatus as set forth in one of claims 5 through 8 characterised in that the torpedo mouthpiece (38) is arranged without a gap on the central inner mandrel (44).

10. Apparatus as set forth in claim 8 characterised in that the cooling mandrel (14) is screwed with a female screwthreaded portion (60) on to the male screwthreaded portion (46) of the central inner mandrel (44).
